(19) United States
(12) Patent Application Publication
(10) Pub. No.: US 2014/0236822 A1
(43) Pub. Date: Aug. 21, 2014

(54) SYSTEM AND METHOD FOR VEHICULAR FLEET MANAGEMENT

(71) Applicant: Manfred King, Lake Ariel, PA (US)

(72) Inventor: Manfred King, Lake Ariel, PA (US)

(21) Appl. No.: 13/771,079

(22) Filed: Feb. 20, 2013

(51) Int. Cl. G06Q 20/22

(52) U.S. Cl. CPC G06Q 20/22
USPC 705/44; 705/39

(57) ABSTRACT

A method for effecting a transaction between a vendor and a customer comprises: transmitting to the purchaser information related to at least one of a vendor service and a vendor commodity selected by the customer; notifying the vendor of tagged funds established in a purchaser bank for payment of at least one of the vendor service and vendor commodity; verifying a delivery to the customer of at least one of the vendor service and vendor commodity; and in response to the step of verifying a delivery, initiating a transfer of the tagged funds

### FIELD OF THE INVENTION

The present invention relates to a system and method for effecting a transaction between a vendor and a customer and, more particularly, to a system and method for managing vehicle fleet fuel and service expenses.

### BACKGROUND OF THE INVENTION

A truck driver operating a rig for a trucking firm needs to stop and refuel along his route. This is often done in a manner similar to that used by the operator of a private vehicle. That is, the vehicle arrives at a fueling station, the vehicle operator has or obtains authorization to fuel up, and the vehicle operator pays for the fuel dispensed, at a service counter.

In a conventional method of managing refueling activities for a fleet of trucks, a vehicle operator for a transportation company pays for fuel and vehicle related services either in cash or by a credit/debit card. Cash is typically problematic for the vehicle operator because large amounts of cash are required to refuel, especially on long trips that require multiple refuels. Carrying large amounts of cash can be a safety concern. If the vehicle operator does not want to carry large amounts of cash, the vehicle operator must stop at a bank or ATM prior to refueling resulting in additional transit time, associated ATM fees, and daily withdrawal limits.

Moreover, the credit card may include a general purchase policy that might not be specific to a vehicle operator or a truck. Accordingly, some drivers may take advantage of this by attempting to sell fuel or the like. Further, since the transaction card might not be tied to a specific vehicle or operator, there is the possibility of other vehicles and operators using the card in an unauthorized manner. In particular, vehicle fleet managers/owners are concerned with the potential for vehicle operators to “piggy-back” and add fuel intended for personal benefit while having access to fleet resources. Since, the transportation company has no way to control in real-time the payment and cost for fuel, it is difficult to prevent the operator from taking advantage or acting fraudulently in the payment process.

Among the shortcomings with conventional methods are that payment by a credit/debit card may also be problematic for the supplier of fuel and vehicle services. Accepting payment by credit/debit cards requires the purchase and maintenance of the appropriate equipment to process the payment. Additionally, the supplier of fuel and vehicle services incurs a transaction fee based on the total purchase amount for each transaction paid via a credit/debit card. Additionally, credit card companies are starting to impose new fees. For example, a new fee by VISA and MasterCard that can be imposed in 40 states is a 4% surcharge. For a typical fuel purchase, this transaction fee is a significant amount and increasing given the rising cost of fuel.

Still further, a driver may be required to manage documentation and information provided, received and/or generated during the processing of a sales transaction. For example, a driver may receive receipts relating to the sales of fuel, services and/or goods. As such, drivers may often forget or lose the numerous amounts of information and documentation produced during a lengthy transportation route. Additionally, the transportation company has no way to control in real-time the payment and cost for gas and diesel fuel. Moreover, the transportation company must manually enter the paper documentation provided by the truck driver in a computer to analyze vehicle related costs. This manual entry method is an extra cost for transportation companies and can result in flawed analysis if information is incorrectly imputed.

Thus, there is a commensurate need to develop a better system and method for the purchase and management of vehicle related costs in the vehicle fleet industry . With the development of telecommunication technology, it is expected that a telecommunication method of non-cash and non-credit card payment can be realized for the driver to pay for fuel under control of real-time cost and finance management by the transportation company. For the transportation company, a method to prevent fraudulent actions of the drivers is also desirable.

### BRIEF SUMMARY OF THE INVENTION

In one aspect of the present invention, a method of effecting a transaction between a vendor and a customer, payment for the transaction being made by a purchaser remote to the customer, the method comprises: transmitting to the purchaser information related to at least one of a vendor service and a vendor commodity selected by the customer; notifying the vendor of tagged funds established in a purchaser bank for payment of at least one of the vendor service and vendor commodity; verifying a delivery to the customer of at least one of the vendor service and vendor commodity; and in response to the step of verifying a delivery, initiating a transfer of the tagged funds.

In another aspect of the present invention, a structured payment system comprises: a first system application software component resident in a vendor accounting terminal, the first system application software operative to process payments for a service rendered or a commodity purchased at a vendor service facility; a second system application software component resident in a purchaser accounting terminal, the second system application software operative to provide a payment authorization for the service rendered or for the commodity purchased at the vendor service facility; and a structured payment server having a third system application software component in communication with the first system application and the second system, the third system application software operative to withdraw funds from a purchaser bank in response to the payment authorization.

In still another aspect of the present invention, a method of providing a service or commodity at a vendor service facility for an asset owned or leased by a purchaser remote to an operator of the purchaser asset, comprises: transmitting to the purchaser, information related to a vendor service or commodity requested by the operator; if purchase of the vendor service or commodity is not authorized by the purchaser, instructing the operator to contact a supervisor; if purchase of the vendor service or commodity is authorized by the purchaser, transmitting a purchase authorization to a vendor operating the vendor service facility; verifying to the purchaser that a vendor service or commodity has been provided to the purchaser asset; and in response to the step of verifying to the purchaser, creating a tagged fund in a purchaser bank, the tagged fund specified as payment for at least a part of the vendor service or commodity provided to the purchaser asset.

The additional features and advantage of the disclosed invention is set forth in the detailed description which follows, and will be apparent to those skilled in the art from the description or recognized by practicing the invention as described, together with the claims and appended drawings.

### BRIEF DESCRIPTION OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a diagrammatical illustration of a structured payment system, in accordance with the present invention;

FIG. 2 is a flow diagram illustrating operation of the structured payment system of FIG. 1; and

FIG. 3 is a flow diagram illustrating an alternate method of transferring approved transactions to a purchaser bank for payment to a vendor.

### DETAIL DESCRIPTION OF THE INVENTION

The following detailed description is of the best currently contemplated modes of carrying out the invention. The description is not to be taken in a limiting sense, but is made merely for the purpose of illustrating the general principles of the invention.

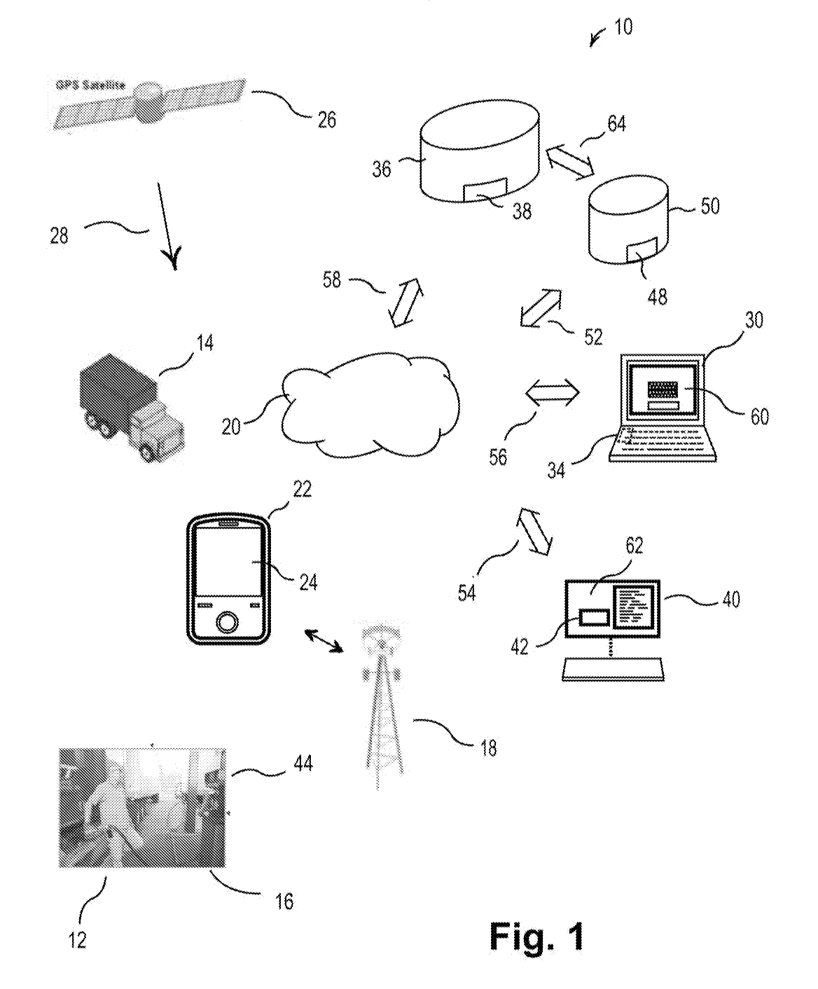

There is shown in FIG. 1 a structured payment system (SPS) 10, herein configured as a system for a fleet of vehicles for purpose of illustration. It should be understood that the structured payment system 10 provides data collection, management, and delivery to commercial entities that need to track business transaction data via communication links to the Internet/cloud 20. Accordingly, the present invention is not limited to a system for a fleet of vehicles, but can be applied for use in similar commercial, private, organizational, charitable, and other non-commercial activities. For example, the present invention can be applied to the purchase of consumer goods by an individual including, but not limited to, groceries, clothing, and electronics.

The structured payment system 10 functions to enable the operator of a truck 14, herein denoted as the customer 12 or trucker, to obtain a desired service or product for the truck 14, for any other type of vehicle in the purchaser fleet, or for any type of purchaser asset, at a vendor service facility 16. In an exemplary embodiment, the vendor service facility 16 includes a fuel pump at which the customer 12 may stop to refuel the truck 14. As explained in greater detail below, the structured payment system 10 enables the customer 12 to: (i) refuel the truck 14 with payment made by a remote purchaser (e.g., by the owner/lessor of the truck 14) and then, (ii) continue on his way in less time than would be necessary with a conventional transaction system.

The customer 12 may have access to a mobile communication device 22, such as a SmartPhone, a cell phone, a tablet computer, or any such personal communication device, communicating via a cell tower 18 or via the Internet/cloud 20, for example. The mobile communication device 22 includes a system application software component 24, in accordance with the present invention, by which the customer 12 is able to obtain the desired service or product for the truck 14, as described in greater detail below. The customer 12 may have been assigned a user ID and password for access to the system application software component 24. Both the mobile communication device 22 and the truck 14 may acquire global positioning system (GPS) signals 28 from a GPS satellite network 26 so as to establish respective geographic positions.

The customer 12 may use the mobile communication device 22 to contact the purchaser by way of a purchaser accounting terminal 30 for the purpose of approving and validating the pending financial transaction. The purchaser accounting terminal 30 may execute a system application software component 34, in accordance with the present invention, to bring up a payment system web portal 60. The payment system web portal 60 enables communication between an agent/employee in the purchaser accounting system and the customer 12 via the system application software component 24 in the mobile communication device 22. This allows for validation of the pending financial transaction by obtaining payment authorization from a bank server 36, at which the purchaser has an account. In an exemplary embodiment, the bank server 36 may execute a system application software component 38, in accordance with the present invention, to provide the payment authorization for the transaction at the vendor service facility 16. In an alternate embodiment, a third party may execute a system application software component 38, in accordance with the present invention, to provide the payment authorization for the transaction at the vendor service facility 16.

The system application software component 38 at the bank may function to communicate with an associated system application software component 42 in a vendor accounting terminal 40 to credit a vendor account for the approved amount of the financial transaction, in accordance with the present invention. A structured payment system server 50 functions via a SPS server link 52 to enable Internet communication between: (i) the customer 12, a vendor employee accessing a vendor web portal 62 at the vendor accounting terminal 40 via a vendor network link 52, (ii) a purchaser employee accessing the payment system web portal 60 at the purchaser accounting terminal 30 via a purchaser network link 54, and (iii) the bank server 36 via a bank network link 58. In an exemplary embodiment, there may be a dedicated communication link 64 between the structured payment system server 50 and the bank server 36 for providing purchaser debit and credit instruction to the bank.

The system application software components 24, 34, and 42 further function to (i) identify the customer, (ii) identify the customer location, (iii) identify the vendor location, (iv) provide authorization rules for the customer, (v) verify the customer bank balance, (vi) authorize the vendor to provide goods and services, and, upon completion of the customer transaction, (vii) instruct the bank to debit and credit the accounts involved with the transaction. Additionally, the system application software components 24, 34, and 42 can further function to display advisements to the user. Preferably, the instruction to the bank is made with a batch transfer at the close of the bank transaction day. That is, the transactions for the day may be collected, and then batch transferred at close of bank transactions. In an exemplary embodiment, the SPS application 48 may: (i) send debit and credit notices to the purchaser bank account and to the vendor accounting department, (ii) update the web portals 60 and 62, and (iii) provide additional reporting capabilities to the purchaser and vendor post sale.

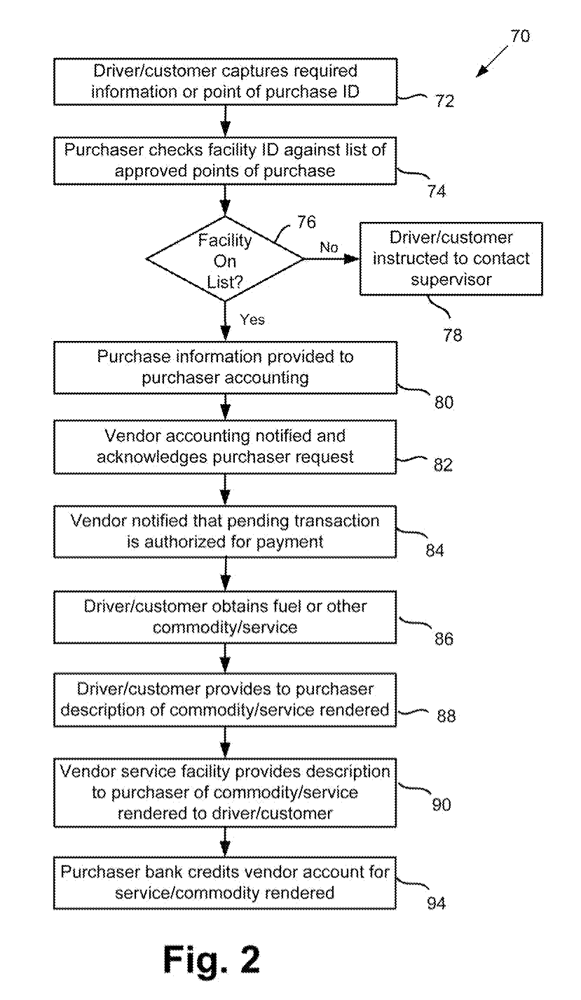

The above-described sequence of procedures may be explained in greater detail with additional reference to a flow chart 70, shown in FIG. 2. The customer 12, herein shown as the truck driver, may arrive at a point of purchase location for obtaining fuel, such as may be available at the vendor service facility 16. Preferably, the vendor service facility 16 is known to the customer 12 as an approved facility or as an approved point of sale, by virtue of having been pre-approved by the purchaser.

The customer 12 may capture information required by the purchaser at the site of the vendor service facility 16, at step 72. The required information may include one or more of, for example: (i) a unique vendor facility ID 44 displayed on the side of the vendor service facility 16 facing the customer 12, (ii) the cost of the fuel at the vendor service facility 16, (iii) the identification of the truck 14, and (iv) the name or employee identification of the customer 12.

In an exemplary embodiment, the vendor facility ID 44 may comprise a 2-D bar code, readable by the mobile communication device 22, as is well-known in the relevant art. The vendor service facility 16 may also display a purchaser-provided decal having a multi-character location code that can be entered into the mobile communication device 22 by the customer 12, if the 2-D bar code is not readable by the mobile communication device 22. In an alternative embodiment, the geographic location of the truck 14 and of the vendor service facility 16 may be obtained for the purchaser using information provided by the GPS satellite network 26.

The purchaser may check the vendor service facility 16 against a list of approved facilities, at step 74. If the vendor service facility 16 is not on the list of approved service facilities, at decision block 76, the customer 12 may be instructed to contact a supervisor, at step 78. The supervisor may provide further instructions to the customer 12 regarding the process of obtaining services, or may instruct the customer 12 to go to a convenient purchaser-approved vendor service facility.

If the vendor service facility 16 has been identified as an approved service facility, at decision block 76, the customer may capture facility information at the site for transmittal via the system application software component 24 in the mobile communication device 22 to the purchaser accounting terminal 30 via the system application software component 34, at step 80.

The system application software component 34 at the purchaser accounting terminal 30 may send a purchase authorization message to the vendor service facility 16 or to the vendor accounting terminal 40 authorizing a purchase, at step 82. The transmittal of the purchase authorization may be made automatically, or may be manually sent by an agent or employee of the purchaser. In an exemplary embodiment, the purchase authorization may appear in a web page accessed from the vendor web portal 62. In this authorization, the purchaser may provide purchase information such as, for example: (i) the name of the purchaser, (ii) the name of the trucking company or of the purchaser, (iii) the name of the customer 12 or the driver, (iv) the phone number of the driver or the customer 12, (v) a fleet number for the truck 14 or other purchaser-owned or purchaser-leased vehicle, and (vi) an authorized amount of purchase.

The vendor service facility 16 or the vendor accounting terminal 40 may acknowledge the purchase request and authorization by responding to the purchaser message. Preferably, the information provided by the purchaser will match the information of the rendered vendor service provided from the vendor service facility 16 or by the vendor accounting terminal 40. If there is no match, a second attempt at matching may be made. If no match is made following a second attempt, a message or phone call may be sent instructing the customer 12 to go to a point of sale or a payment counter associated with the vendor service facility 16 and complete the purchase in a conventional manner.

If a match does occur, the purchasing process may continue by querying the purchaser bank (i.e., the bank server 36), and approving the purchase amount against a specified purchaser account. The vendor accounting terminal 40 is notified accordingly, at step 84. The customer 12 receives a notice on the mobile communication device 22 that the pump is turned on at the vendor service facility 16, and the customer 12 then can pump the fuel or otherwise complete the purchase, at step 86. Using the mobile communication device 22, the customer 12 may record the amount of fuel delivered and/or the total price of the fuel pumped, at step 88. This information of the service rendered may then be provided to the purchaser accounting terminal 30 via the system application software component 34. The bank server 36 may then deduct from the purchaser account balance an amount equal to the actual amount calculated at the vendor service facility 16 plus a service fee determined by the SPS application 48.

The purchaser accounting terminal 30 may then contact the vendor service facility 16 and request verification of the amount of fuel delivered and/or the total transaction cost. The vendor service facility 16 may then send the requested information to the purchaser accounting terminal 30, at step 90, to validate the transaction information. In an exemplary embodiment, a small difference in transaction cost between the figure reported by the driver, and the transaction cost reported by the vendor accounting terminal 40, will not invalidate the transaction, as the display on the vendor service facility 16 may be slightly off-calibration. In such cases, a substantial match between the transaction information provided by the vendor service facility and the transaction information provided by the driver may be acceptable and a precise match may not be required.

In some cases, the vendor service facility 16 may not display transaction cost, but only the amount of fuel delivered. In an exemplary embodiment, the purchaser accounting terminal 30 may require the driver to input: (i) all displayed information, (ii) the truck/equipment information, (iii) miles driven, (iv) hours operated, and (v) an identification of the vendor service facility 16 for internal purchaser use. Movement of the truck 14 may also be automatically tracked by the GPS satellite network 26 and reported to the purchaser accounting terminal 30.

Once the transaction has been completed, the purchaser accounting terminal 30 may forward a message to the vendor service facility 16 stating that financial details have been approved, at step 92, and that the bank server 36 has transferred credit to the vendor service facility 16. In an exemplary embodiment, the driver or customer 12 may also receive an acknowledgement of a successful transaction.

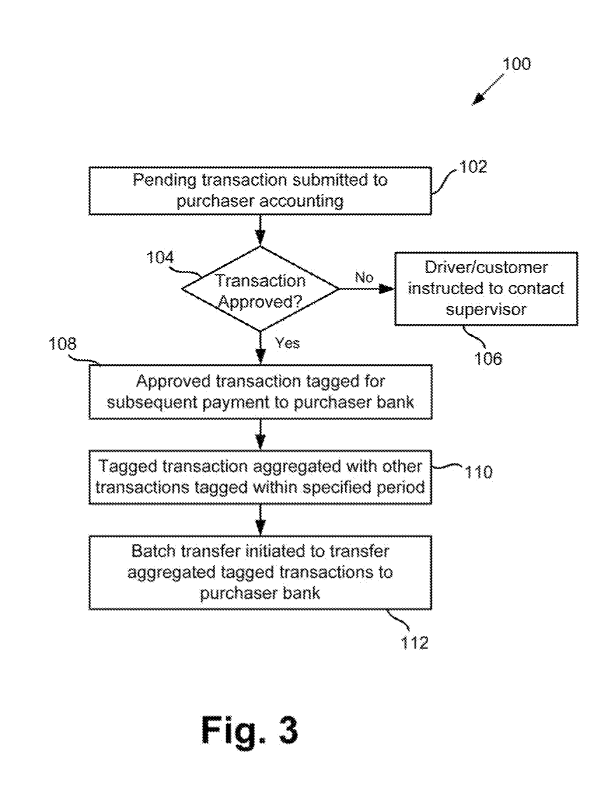

In an exemplary embodiment, illustrated with reference to a flow diagram 100 in FIG. 3, the pending transaction may be submitted to the purchaser accounting terminal 30, at step 102. If the pending transaction is not approved, at decision block 104, the driver or customer may be instructed to contact a supervisor, at step 106, before proceeding further. If the pending transaction is approved, at decision block 104, the approved transaction may be tagged for payment, at step 108. The purchaser accounting terminal 30 and the system application software component 34 may aggregate the tagged funds with tagged funds for other payment transactions before submittal to the purchaser bank, at step 110. Preferably, the aggregation of tagged funds is performed for a specified period, such as a period of one business day. At the termination of the business day, for example, a batch transfer of the aggregate of tagged funds for payment transactions may be transmitted to the purchaser bank, at step 112.

It is to be understood that the description herein is exemplary of the invention only and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

What is claimed is:

1. A method of effecting a transaction between a vendor and a customer, payment for the transaction being made by a purchaser remote to the customer, said method comprising the steps of:
transmitting to the purchaser information related to at least one of a vendor service and a vendor commodity selected by the customer;
notifying the vendor of tagged funds established in a purchaser bank for payment of said at least one of said vendor service and said vendor commodity;
verifying a delivery to the customer of at least one of said vendor service and said vendor commodity; and
in response to said step of verifying a delivery, initiating a transfer of said tagged funds.

2. The method of claim 1 wherein said step of transmitting to the purchaser is executed by the customer at a vendor service facility.

3. The method of claim 2 further comprising the step of establishing that said vendor service facility is listed by the customer as an approved point of purchase.

4. The method of claim 3 wherein said step of establishing comprises the step of comparing the geographic location of the customer with a known geographic location for said vendor service facility.

5. The method of claim 3 wherein said step of establishing comprises the step of reading at least one of (i) a 2-D bar code or (ii) a purchaser-provided decal having a multi-character location code thereon, provided at said vendor service facility.

6. The method of claim 2 further comprising the step of providing to the purchaser a description of the vendor service or the vendor commodity delivered to the customer.

7. The method of claim 6 wherein said step of verifying a delivery comprises the step of comparing transaction information provided by the customer with transaction information provided by the vendor.

8. The method of claim 2 wherein the customer executes said step of transmitting to the purchaser by using a mobile communication device.

9. The method of claim 1 wherein, in response to said step of transmitting to the purchaser, the purchaser transmits an authorization for obtaining said at least one of a vendor service and said vendor commodity, said authorization transmitted to at least one of the customer, the vendor, and a vendor service facility.

10. The method of claim 1 wherein said information related to at least one of a vendor service and a vendor commodity selected by the customer comprises at least one of: (i) a vendor facility identification displayed at a vendor service facility, (ii) a cost for service to be rendered at said vendor service facility, (iii) a cost for a commodity to be obtained at said vendor service facility, (iv) an identification of a purchaser asset receiving said at least one of said vendor service and said vendor commodity, and (v) an identification of the customer.

11. The method of claim 1 further comprising the step of notifying at least one of the vendor and a vendor service facility that payment for said at least one of said vendor service and said vendor commodity has been initiated.

12. The method of claim 1 wherein said step of initiating a transfer of said tagged funds comprises one of: (i) the step of transferring said tagged funds as part of a batch transfer, or (ii) the step of transferring said tagged funds as an individual transfer.

13. A structured payment system comprising:
a first system application software component resident in a vendor accounting terminal, said first system application software operative to process payments for a service rendered or a commodity purchased at a vendor service facility;
a second system application software component resident in a purchaser accounting terminal, said second system application software operative to provide a payment authorization for said service rendered or for said commodity purchased at said vendor service facility; and
a structured payment server having a third system application software component in communication with said first system application and said second system, said third system application software operative to withdraw funds from a purchaser bank in response to said payment authorization.

14. The structured payment system of claim 13 further comprising a dedicated communication link between said structured payment server and a purchaser bank server.

15. The structured payment system of claim 13 further comprising a fourth system application software component resident in a mobile communication device, said fourth system application software component operative to provide to said purchaser accounting terminal information related to said vendor service facility.

16. The structured payment system of claim 13 wherein said vendor service facility is identified by said structured payment server as a pre-approved service facility.

17. A method of providing a service or commodity at a vendor service facility for an asset owned or leased by a purchaser remote to an operator of the purchaser asset, said method comprising the steps of:
transmitting to the purchaser, information related to a vendor service or commodity requested by the operator;
if purchase of said vendor service or commodity is not authorized by the purchaser, instructing the operator to contact a supervisor;
if purchase of said vendor service or commodity is authorized by the purchaser, transmitting a purchase authorization to a vendor operating the vendor service facility;
verifying to the purchaser that a vendor service or commodity has been provided to the purchaser asset; and
in response to said step of verifying to the purchaser, creating a tagged fund in a purchaser bank, said tagged fund specified as payment for at least a part of said vendor service or commodity provided to the purchaser asset.

18. The method of claim 17 further comprising the step of placing said tagged fund into an aggregate of tagged funds, whereby said aggregate of tagged funds is batch transferred after a specified period of time.

19. The method of claim 17 wherein said step of verifying to the purchaser comprises the steps of.
providing to the purchaser, via the operator, transaction information related to the vendor service or commodity provided to the purchaser asset; and
authorizing said tagged fund as a payment for said vendor service or commodity provided to the purchaser asset if transaction information provided by the vendor service facility substantially matches said transaction information provided by the operator.

20. The method of claim 17 further comprising the step of establishing that the vendor service facility is listed by the customer as a pre-approved point of purchase by comparing the global positioning system coordinates of the customer with a known geographic location for said vendor service facility.
